(19) United States
(12) Patent Application Publication
(10) Pub. No.: US 2025/0385929 A1
(43) Pub. Date: Dec. 18, 2025

(54) INFORMATION PROCESSING SYSTEM, INFORMATION PROCESSING APPARATUS, AND INFORMATION PROCESSING METHOD

(71) Applicant: Panasonic Automotive Systems Co., Ltd., Kanagawa (JP)

(72) Inventors: Daichi MINAMIDE, Osaka (JP); Naoki OCHI, Osaka (JP); Kouji KOBAYASHI, Kanagawa (JP); Takumaru NAGAI, Osaka (JP)

(73) Assignee: Panasonic Automotive Systems Co., Ltd., Kanagawa (JP)

(21) Appl. No.: 19/230,781

(22) Filed: Jun. 6, 2025

(30) Foreign Application Priority Data
Jun. 14, 2024 (JP) 2024-096509

(51) Int. Cl. H04L 9/40; G06V 20/56; G07C 5/08

(52) U.S. Cl. CPC H04L 63/1425; G06V 20/56; G07C 5/08

(57) ABSTRACT

An information processing system includes: an information obtainer that obtains surrounding information of a vehicle and in-vehicle log information indicating an in-vehicle log of the vehicle; an information processor that derives, based on the surrounding information and the in-vehicle log information indicating an in-vehicle log of the vehicle, a relationship between an accident in which the vehicle has been involved and a cyber attack to which the vehicle has been subjected; and an outputter that outputs information indicating the relationship between the accident in which the vehicle has been involved and the cyber attack.

### CROSS REFERENCE TO RELATED APPLICATION

The present application is based on and claims priority of Japanese Patent Application No. 2024-096509 filed on Jun. 14, 2024.

### FIELD

The present disclosure relates to an information processing system, information processing apparatus, and information processing method.

### BACKGROUND

Conventionally, an analysis apparatus for analyzing vehicle security is known. As an example of this analysis apparatus, Patent Literature (PTL) 1 discloses an analysis apparatus capable of identifying a cyber attack scenario based on the correlation among a plurality of individual attack patterns that occurred within a predetermined period.

### CITATION LIST

### Patent Literature

PTL 1: Japanese Unexamined Patent Application Publication No. 2023-46923

### SUMMARY

However, the analysis apparatus according to PTL 1 can be improved upon.

In view of this, the present disclosure provides an information processing system capable of improving upon the above related art.

An information processing system according to one aspect of the present disclosure includes: an information obtainer that obtains surrounding information of a vehicle and in-vehicle log information indicating an in-vehicle log of the vehicle; an information processor that derives, based on the surrounding information and the in-vehicle log information indicating an in-vehicle log of the vehicle, a relationship between an accident in which the vehicle has been involved and a cyber attack to which the vehicle has been subjected; and an outputter that outputs information indicating the relationship between the accident in which the vehicle has been involved and the cyber attack.

An information processing apparatus according to one aspect of the present disclosure includes: an information obtainer that obtains surrounding information of a vehicle and in-vehicle log information indicating an in-vehicle log of the vehicle; an information processor that derives, based on the surrounding information and the in-vehicle log information indicating an in-vehicle log of the vehicle, a relationship between an accident in which the vehicle has been involved and a cyber attack to which the vehicle has been subjected; and an outputter that outputs information indicating the relationship between the accident in which the vehicle has been involved and the cyber attack.

An information processing method according to one aspect of the present disclosure includes: obtaining surrounding information of a vehicle and in-vehicle log information indicating an in-vehicle log of the vehicle; deriving, based on the surrounding information and the in-vehicle log information indicating an in-vehicle log of the vehicle, a relationship between an accident in which the vehicle has been involved and a cyber attack to which the vehicle has been subjected; and outputting information indicating the relationship between the accident in which the vehicle has been involved and the cyber attack.

The information processing system according to one aspect of the present disclosure can be further improved.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a diagram illustrating a schematic configuration of an information processing system according to a comparative example.

FIG. 2 is a diagram illustrating a schematic configuration of an information processing system according to an embodiment.

FIG. 3 is a block diagram illustrating the functional configuration of the information processing system according to the embodiment.

FIG. 4 is a diagram illustrating an example of surrounding information including accident information of a vehicle.

FIG. 5 is a diagram illustrating an example of the driving function information and cyber attack information of the vehicle.

FIG. 6 is a diagram illustrating an example of the relationship among the accident information, the driving function information, and the cyber attack information.

FIG. 7 is a sequence diagram illustrating the operation of the information processing system according to the embodiment.

FIG. 8 is a diagram illustrating a schematic configuration of an information processing system according to Variation 1 of the embodiment.

FIG. 9 is a block diagram illustrating a functional configuration of the information processing system according to Variation 1 of the embodiment.

FIG. 10 is a sequence diagram illustrating the operation of an information processing system according to Variation 1 of the embodiment.

FIG. 11 is a diagram illustrating a schematic configuration of an information processing system according to Variation 2 of the embodiment.

FIG. 12 is a block diagram illustrating the functional configuration of the information processing system according to Variation 2 of the embodiment.

FIG. 13 is a sequence diagram illustrating the operation of the information processing system according to Variation 2 of the embodiment.

FIG. 14 is a diagram illustrating another example of the information processing system according to the embodiment.

### DESCRIPTION OF EMBODIMENTS

### (Circumstances Leading to the Present Disclosure)

The background to the present disclosure will be described with reference to a comparative example.

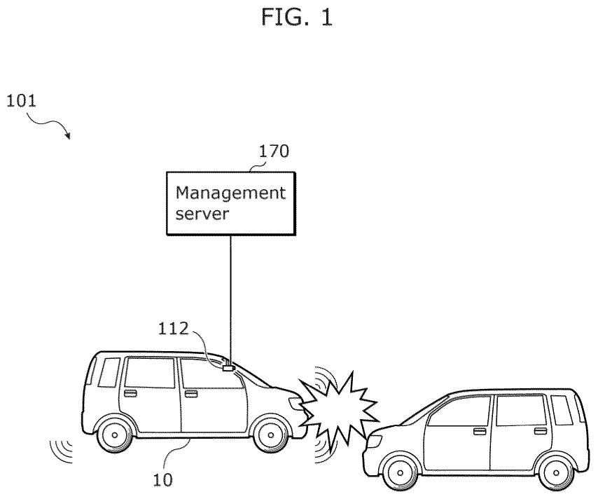

FIG. 1 is a diagram illustrating a schematic configuration of information processing system 101 according to the comparative example.

Note that FIG. 1 also illustrates vehicle 10 traveling on a road. Vehicle 10 is equipped with drive recorder 112 that records video data of the vicinity of vehicle 10.

Information processing system 101 of the comparative example includes management server 170 communicatively connected to vehicle 10 via a communication network. Management server 170 is a server operated by an insurance company, for example. When an accident occurs in vehicle 10, management server 170 obtains video data output from drive recorder 112 and analyzes the vehicle accident based on the video data.

A vehicle accident may occur not only due to the driver's fault or the failure of vehicle 10 itself, but also due to a cyber attack on vehicle 10. However, in information processing system 101 of the comparative example, it is difficult to determine whether the vehicle accident has occurred due to a cyber attack on vehicle 10, leading to the problem of insufficient verification of the vehicle accident.

The present disclosure has the following structure to reduce insufficient verification of the vehicle accident.

Exemplary embodiments will be specifically described below with reference to the drawings. Note that all of the embodiments described below are comprehensive or specific examples. The numerical values, components, arrangement positions and connection forms of components, steps, order of steps, and the like shown in the following embodiments are examples and are not intended to limit the present disclosure. Among the components in the following embodiments, those not described in the independent claims will be described as optional components.

In the present specification, terms indicating the relationship among elements such as coincidence, numerical values, and numerical ranges are expressions that do not only express a strict meaning, but also include substantially equivalent ranges, for example, differences of a few percent (for example, around 10%).

### Embodiment

### [Configuration of Information Processing System]

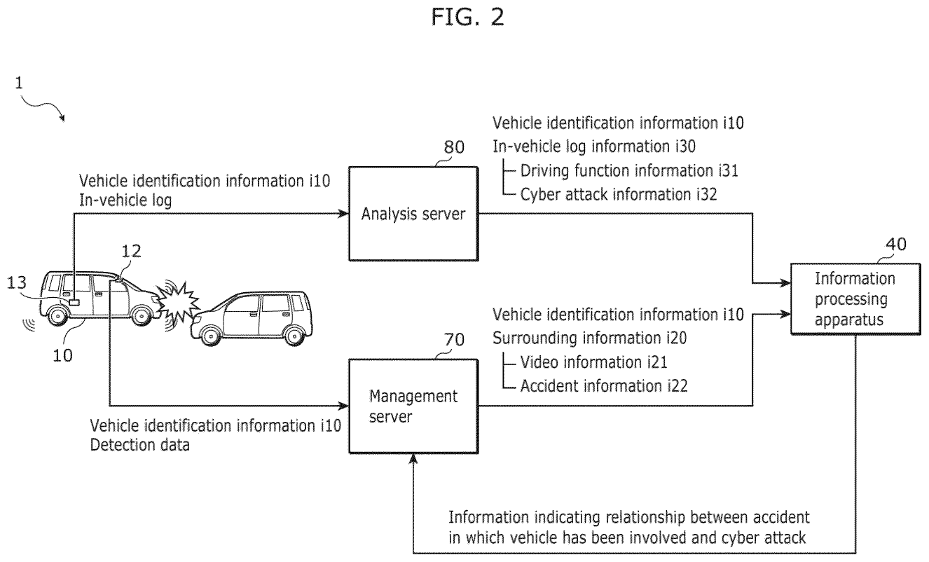

The configuration of an information processing system according to an embodiment will be described with reference to FIGS. 2 to 6. The information processing system is a system that presents the relationship between an accident in which vehicle 10 has been involved and a cyber attack to which vehicle 10 has been subjected.

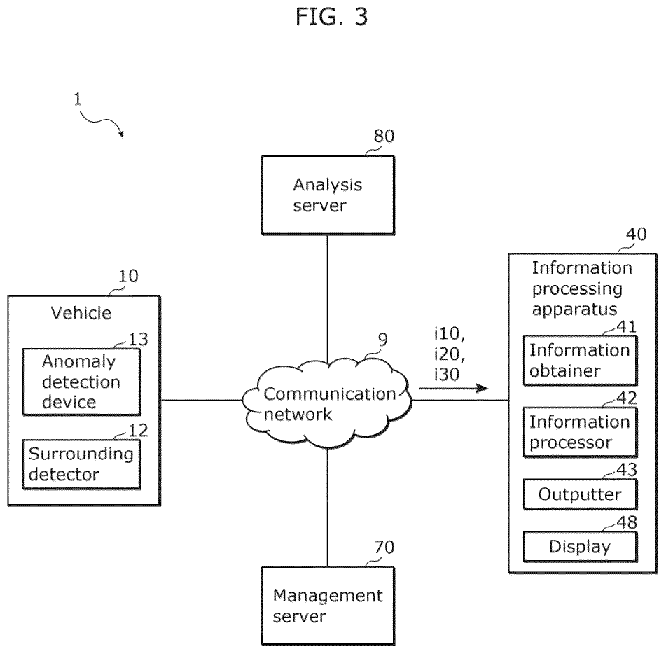

FIG. 2 is a diagram illustrating a schematic configuration of information processing system 1 according to the embodiment. FIG. 3 is a block diagram illustrating a functional configuration of information processing system 1.

As illustrated in FIGS. 2 and 3, information processing system 1 includes analysis server 80, management server 70, and information processing apparatus 40. Vehicle 10 is also illustrated in these diagrams.

Vehicle 10 can communicate with each of analysis server 80 and management server 70 via communication network 9. Specifically, vehicle 10 and analysis server 80 can communicate with each other through a telematics control unit (TCU). Vehicle 10 and management server 70 can communicate with each other through independent communication of surrounding detector 12, which will be described later. Each of analysis server 80 and management server 70 can communicate with information processing apparatus 40 via communication network 9.

Vehicle 10 is a vehicle to be analyzed in an accident. Vehicle 10 is a four-wheeled vehicle such as a car, bus, or truck, or a two-wheeled vehicle such as a motorcycle. Vehicle 10 is, for example, a vehicle driven by a driver, but is not limited thereto and may also be a vehicle capable of automatic travel. Information processing system 1 obtains various types of information from a plurality of vehicles 10 and analyzes an accident in which each vehicle 10 has been involved.

Vehicle 10 is provided with surrounding detector 12 and anomaly detection device 13.

Surrounding detector 12 is a device that detects a situation around vehicle 10. Surrounding detector 12 is, for example, at least one of a drive recorder or light detection and ranging (LIDAR) device and outputs detection data indicating a situation outside vehicle 10. The detection data is, for example, video data and three-dimensional image data.

Surrounding detector 12 outputs the detection data detected by surrounding detector 12 to management server 70 via communication network 9. For example, surrounding detector 12 outputs detection data for a certain time period before and after an accident involving vehicle 10 to management server 70 Surrounding detector 12 also outputs, to information processing apparatus 40, identification information i10 of vehicle 10 that has been involved in the accident and the time (including date and time) when the accident occurred. Identification information i10 may be the identification number of vehicle 10 itself or the physical address of surrounding detector 12 attached to each vehicle 10.

Note that the certain time period before and after the accident is, for example, 10 seconds before and 10 seconds after an accident occurs in vehicle 10. The certain time period is appropriately selected from a range of 5 seconds or more and 15 seconds or less and is set in advance. Whether vehicle 10 has been involved in an accident can be determined by a collision detection sensor built into surrounding detector 12. However, when surrounding detector 12 does not include a collision detection sensor, surrounding detector 12 may detect a collision using an acceleration sensor or a shock sensor provided in vehicle 10, and output detection data for a certain time period before and after the detection of the collision to management server 70. In the above, an example in which surrounding detector 12 is directly connected to communication network 9 is shown. However, when surrounding detector 12 does not include a wireless module, surrounding detector 12 may output the above detection data to management server 70 via an in-vehicle communication module and communication network 9.

Management server 70 is a server for managing an automobile insurance system and is operated, for example, by an insurance company. Management server 70 analyzes the detection data output from vehicle 10 to obtain surrounding information 120 including information on the surrounding situation of vehicle 10. For example, management server 70 obtains surrounding information i20 for a certain time period before and after an accident involving vehicle 10.

Surrounding information i20 includes video information i21 on the outside of vehicle 10. Management server 70 obtains video information i21 to analyze video data output from the drive recorder.

Surrounding information i20 includes accident information i22 on an accident in which vehicle 10 has been involved.

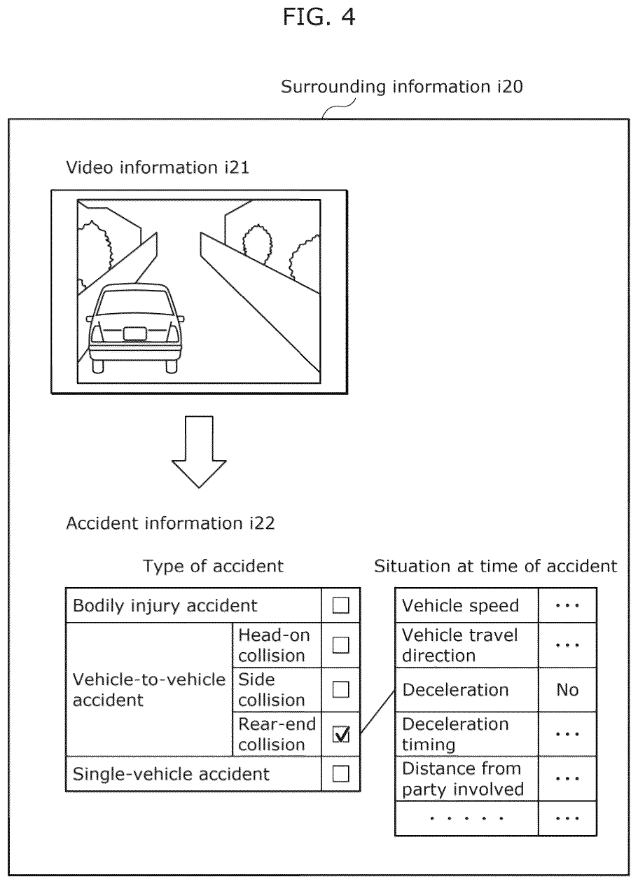

FIG. 4 is a diagram illustrating an example of surrounding information i20 including accident information i22 of vehicle 10.

Accident information i22 is information on the type of vehicle accident and the situation at the time of the accident.

Management server 70 analyzes the video data and the like output from vehicle 10 to obtain information on the type of accident. The type of accident is classified, for example, as a bodily injury accident, a vehicle-to-vehicle accident, or a single-vehicle accident. A vehicle-to-vehicle accident is further classified into a head-on collision, a side collision, a rear-end collision, and the like.

Management server 70 analyzes the above video data and the like to identify the situation at the time of the accident. The situation at the time of the accident is the travel state of vehicle 10 at the time of the accident, such as the speed, travel direction, deceleration or no deceleration, and deceleration timing of vehicle 10, and the distance from a party (person or vehicle) involved. FIG. 4 illustrates an example in which the accident in which vehicle 10 has been involved is a rear-end collision and the situation at the time of the accident is “no deceleration”. Note that management server 70 may identify the situation at the time of the accident, including not only a determination by a computer but also a determination result by a person, such as an insurance investigator.

Management server 70 outputs surrounding information i20 including video information i21 and accident information i22, described above, to information processing apparatus 40 via communication network 9. Management server 70 also outputs identification information i10 of vehicle 10 that has been involved in the accident and the accident occurrence time to information processing apparatus 40.

Next, anomaly detection device 13 provided in vehicle 10 will be described. Anomaly detection device 13 detects the occurrence of an anomaly in vehicle 10. For example, anomaly detection device 13 measures the speed, acceleration, steering angle, and other parameters of vehicle 10 and detects whether an anomaly has occurred based on the measurement results. Anomaly detection device 13 detects whether an anomaly has occurred based on whether a control signal for controlling vehicle 10 includes a signal that causes an anomalous operation.

Anomaly detection device 13 outputs an in-vehicle log including the detection result of whether an anomaly has occurred in the in-vehicle system to analysis server 80 via communication network 9. The in-vehicle log includes information on the type of anomaly, the location where the anomaly occurred, the details of the anomaly, and the time (including date and time) when the anomaly occurred. When outputting the in-vehicle log, vehicle 10 also outputs identification information i10 of vehicle 10 to analysis server 80. Vehicle 10 may output the position (for example, global coordinates) of vehicle 10 at the time of the anomaly to analysis server 80.

Analysis server 80 is a server that detects and analyzes a cyber attack and takes countermeasures against the cyber attack. Analysis server 80 is provided in a security operation center (SOC) of a vehicle manufacturing company or the like.

Analysis server 80 obtains the in-vehicle log output from vehicle 10 and analyzes the in-vehicle log to obtain driving function information i31 indicating whether an anomaly has occurred in the driving function of vehicle 10. For example, driving function information i31 includes information indicating whether an anomaly has occurred in at least one of the steering wheel, the brake, or the accelerator.

Analysis server 80 analyzes the in-vehicle log to detect whether a cyber attack has occurred and obtain cyber attack information i32 as to whether a cyber attack has occurred. Cyber attack information i32 includes an attack scenario on the in-vehicle system of vehicle 10. The attack scenario refers to attack details presented in time series and includes, for example, when and how a hacker entered vehicle 10 and how the hacker attacked the driving function of vehicle 10. Examples of the attack details include “port scanning”, “buffer overflow”, “denial of service attack (DoS)”, “unauthorized access”, “firmware (FW) update”, “unauthorized communication (unnatural communication)”, “unauthorized command”, and “memory access error”. Note that cyber attack information i32 may include not only information indicating whether vehicle 10 was actually subjected to a cyber attack but also whether there is a possibility of a cyber attack on vehicle 10.

Analysis server 80 derives the relationship between whether an anomaly has occurred in the driving function of vehicle 10 and whether a cyber attack has occurred.

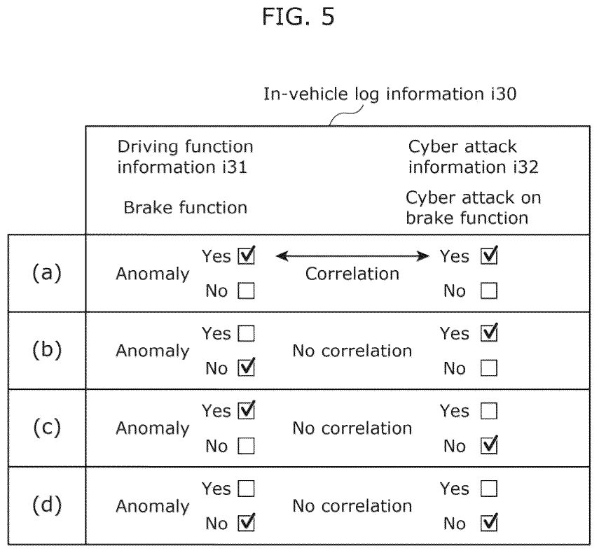

FIG. 5 illustrates an example of driving function information i31 and cyber attack information i32 of vehicle 10.

FIG. 5 illustrates the relationship between whether an anomaly has occurred in the brake function, which is an example of the driving function, and whether a cyber attack has targeted the brake function.

For example, as illustrated in (a) in FIG. 5, when an anomaly has occurred in the brake function and a cyber attack has targeted the brake function, analysis server 80 determines that there is a correlation between the cyber attack and the anomaly in the brake function. As illustrated in (b) in FIG. 5, when no anomaly has occurred in the brake function and a cyber attack has targeted the brake function, analysis server 80 determines that there is no correlation between the cyber attack and the brake function. As illustrated in (c) in FIG. 5, when an anomaly has occurred in the brake function and no cyber attack has targeted the brake function, analysis server 80 determines that there is no correlation between the cyber attack and the anomaly in the brake function. As illustrated in (d) in FIG. 5, when no anomaly has occurred in the brake function and no cyber attack has targeted the brake function, analysis server 80 determines that there is no correlation between the cyber attack and the anomaly in the brake function.

Note that analysis server 80 may determine the correlation between whether an anomaly has occurred in the brake function and whether a cyber attack has occurred, including not only a determination by a computer but also a determination result by a person, such as an analysis staff.

The above description has been given of the relationship between whether an anomaly has occurred in the brake function and whether a cyber attack has occurred. However, the relationship between whether an anomaly has occurred in the steering function and whether a cyber attack has occurred, as well as the relationship between whether an anomaly has occurred in the accelerator function and whether a cyber attack has occurred, can also be represented in the same way as above (not illustrated).

Analysis server 80 outputs information i30 on the in-vehicle log, including driving function information i31 and cyber attack information i32, to information processing apparatus 40 via communication network 9. Analysis server 80 also outputs identification information i10 of vehicle 10 that has been involved in the accident to information processing apparatus 40.

Information processing apparatus 40 is an apparatus that derives the relationship between the accident in which vehicle 10 has been involved and the cyber attack, and is provided, for example, in an information security company. As illustrated in FIG. 3, information processing apparatus 40 includes information obtainer 41, information processor 42, and outputter 43. Information processing apparatus 40 is formed of a microcontroller (integrated circuit (IC) including a processor and a memory). The functions of information obtainer 41, information processor 42, and outputter 43 are implemented by the processor executing a computer program stored in a memory.

Information obtainer 41 obtains surrounding information i20 output from management server 70, identification information i10 of vehicle 10, and information on the accident occurrence time. Surrounding information i20 includes video information i21 and accident information i22 described above. Information obtainer 41 also obtains information i30 on the in-vehicle log and identification information i10 of vehicle 10 output from analysis server 80. Information i30 on the in-vehicle log includes driving function information i31 and cyber attack information i32 described above, and information on the anomaly occurrence time.

Information processor 42 collates identification information i10 of vehicle 10 and the accident occurrence time, output from management server 70, with identification information i10 of vehicle 10 and the anomaly occurrence time, output from analysis server 80, identifies the target vehicle, and performs the following processing.

Information processor 42 derives the relationship between the accident in which vehicle 10 has been involved and the cyber attack on vehicle 10 based on surrounding information i20 and information i30 on the in-vehicle log. For example, information processor 42 derives the relationship between the accident in which vehicle 10 has been involved and the cyber attack based on the relationship between accident information i22 and driving function information i31, as well as the relationship between driving function information i31 and cyber attack information i32.

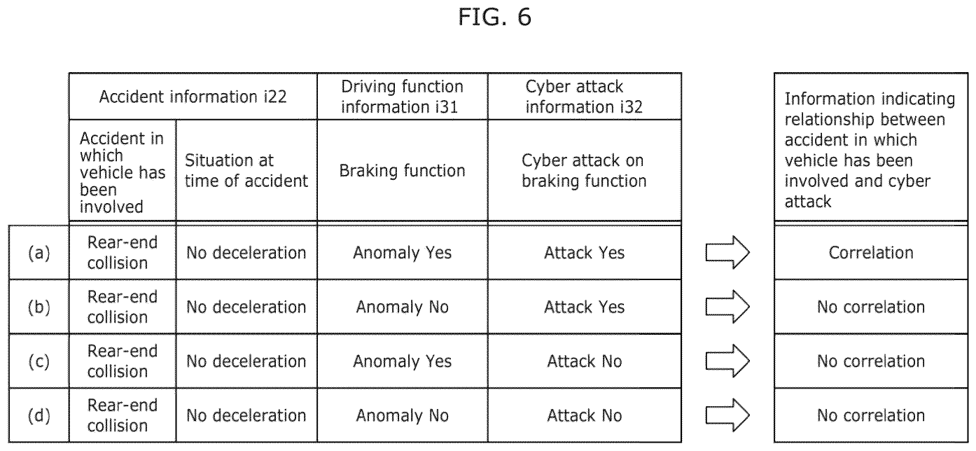

FIG. 6 is a diagram illustrating an example of the relationship among accident information i22, driving function information i31, and cyber attack information i32.

FIG. 6 illustrates the relationship among accident information i22, driving function information i31, and cyber attack information i32 in a state where the situation at the time of the accident, as indicated in accident information i22, and whether an anomaly has occurred in the driving function, as indicated in driving function information i31, are linked.

In FIG. 6, the case of a rear-end collision with vehicle 10 will be described as an example. FIG. 6 illustrates an example of no deceleration as the situation at the time of the rear-end collision. FIG. 6 also illustrates whether an anomaly has occurred in the brake function, which is an example of a driving function, and further illustrates whether a cyber attack has targeted the brake function.

For example, as illustrated in (a) in FIG. 6, when the situation at the time of the rear-end collision is no deceleration, an anomaly has occurred in the brake function, and a cyber attack has targeted the brake function, information processing apparatus 40 determines that there is a correlation between the rear-end collision and the cyber attack. In this case, information processing apparatus 40 may assume that the cyber attack is the cause of the accident other than the driver's fault and the failure of vehicle 10 itself. In addition, information processing apparatus 40 may assume that the rear-end collision has occurred due to an attack on the brake function based on the attack scenario analyzed by analysis server 80.

As illustrated in (b) in FIG. 6, when the situation at the time of the rear-end collision is no deceleration, no anomaly has occurred in the brake function, and a cyber attack has targeted the brake function, information processing apparatus 40 determines that there is no correlation between the rear-end collision and the cyber attack. In this case, since no anomaly has occurred in the brake function, information processing apparatus 40 may assume that the driver's fault or another driving function different from the brake function is the cause of the accident.

As illustrated in (c) in FIG. 6, when the situation at the time of the rear-end collision is no deceleration, an anomaly has occurred in the brake function, and no cyber attack has targeted the brake function, information processing apparatus 40 determines that there is no correlation between the rear-end collision and the cyber attack. In this case, since an anomaly has occurred in the brake function, information processing apparatus 40 may assume that the failure of vehicle 10 itself is the cause of the accident.

As illustrated in (d) in FIG. 6, when the situation at the time of the rear-end collision is no deceleration, no anomaly has occurred in the brake function, and no cyber attack has targeted the brake function, information processing apparatus 40 determines that there is no correlation between the rear-end collision and the cyber attack. In this case, information processing apparatus 40 may assume that the driver's fault or another driving function different from the brake function is the cause of the accident.

Thus, information processor 42 derives the relationship between the accident in which vehicle 10 has been involved and the cyber attack on vehicle 10 based on accident information i22, driving function information i31, and cyber attack information i32.

Outputter 43 outputs information indicating the relationship between the accident in which vehicle 10 has been involved and the cyber attack to display 48 provided in information processing apparatus 40. Display 48 is, for example, a liquid crystal display device or the like, and displays information indicating the relationship between the accident in which vehicle 10 has been involved and the cyber attack.

Outputter 43 also outputs information indicating the relationship between the accident in which vehicle 10 has been involved and the cyber attack to management server 70. Management server 70 verifies the vehicle accident based on the information indicating the relationship between the accident in which vehicle 10 has been involved and the cyber attack.

Information processing system 1 according to the present embodiment includes: information obtainer 41 that obtains surrounding information i20 of vehicle 10 and information i30 on the in-vehicle log of vehicle 10; information processor 42 that derives the relationship between an accident in which vehicle 10 has been involved and a cyber attack to which vehicle 10 has been subjected based on surrounding information i20 and information i30 on the in-vehicle log; and outputter 43 that outputs information indicating the relationship between the accident in which vehicle 10 has been involved and the cyber attack.

Thus, by deriving the relationship between the accident in which vehicle 10 has been involved and the cyber attack to which vehicle 10 has been subjected based on surrounding information i20 and information i30 on the in-vehicle log of vehicle 10, insufficient verification of the vehicle accident can be reduced.

### [Operation of Information Processing System]

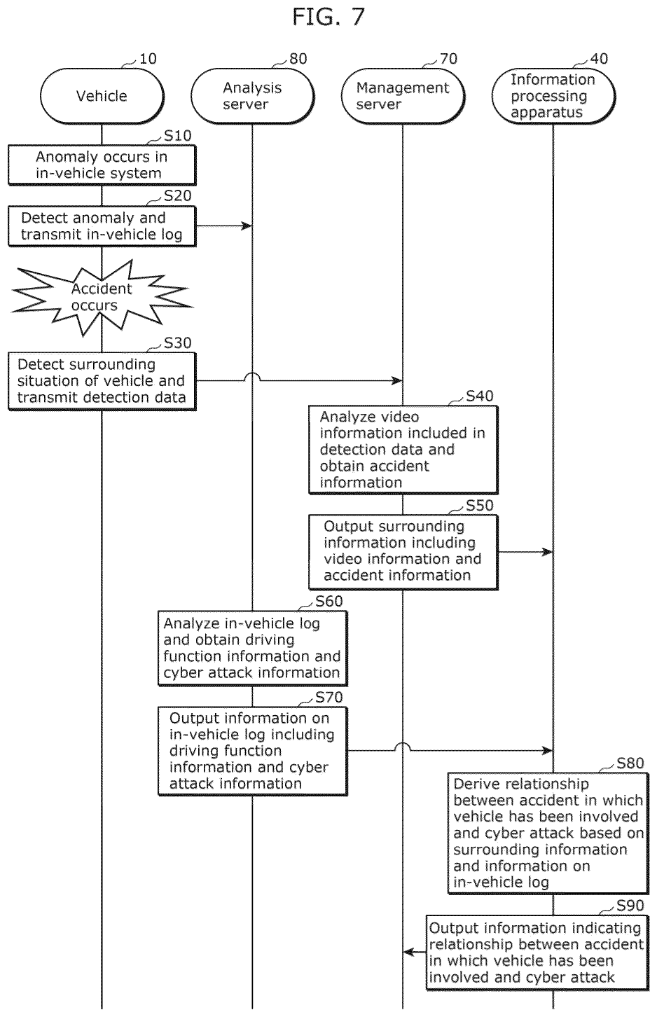

The operation of information processing system 1 described above will be described with reference to FIG. 7. In this example, the case of a cyber attack on vehicle 10 will be taken as an example.

FIG. 7 is a sequence diagram illustrating the operation of information processing system 1.

First, vehicle 10 is subjected to a cyber attack, causing an anomaly in the in-vehicle system of vehicle 10 (step S10).

Anomaly detection device 13 of vehicle 10 detects an anomaly occurring in the in-vehicle system and transmits the in-vehicle log to analysis server 80 (step S20).

The anomaly in the in-vehicle system causes an accident to occur in vehicle 10. Then, surrounding detector 12 of vehicle 10 detects the surrounding situation of vehicle 10 at the time of the accident and transmits the detection data to management server 70 (step S30). Note that the detection data includes video information i21 for a certain time period before and after the accident involving vehicle 10.

Management server 70 analyzes video information i21 included in the detection data and obtains accident information i22 (step S40). Accident information i22 includes information on the type of accident and the situation at the time of the accident. Management server 70 transmits surrounding information i20 including video information i21 and accident information i22 to information processing apparatus 40 (step S50).

Meanwhile, analysis server 80 analyzes the in-vehicle log transmitted from anomaly detection device 13 and obtains driving function information i31 and cyber attack information i32 (step S60). Driving function information i31 is information indicating whether an anomaly has occurred in the driving function of vehicle 10 and includes information indicating whether an anomaly has occurred in at least one of the steering wheel, the brake, or the accelerator of vehicle 10. Cyber attack information i32 is information indicating the cyber attack to which vehicle 10 has been subjected and includes an attack scenario on the in-vehicle system of vehicle 10. Analysis server 80 transmits information i30 on the in-vehicle log, including driving function information i31 and cyber attack information i32, to information processing apparatus 40 (step S70). As long as steps S60 and S70 are executed after step S20, execution of steps S60 and S70 may take place before or at the same time as steps S40 and S50.

Information processing apparatus 40 derives the relationship between the accident in which vehicle 10 has been involved and the cyber attack to which vehicle 10 has been subjected based on surrounding information i20 transmitted from management server 70 and information i30 on the in-vehicle log transmitted from analysis server 80 (step S80). For example, information processor 42 derives the relationship between the accident in which vehicle 10 has been involved and the cyber attack based on the relationship between accident information i22 and driving function information i31, as well as the relationship between driving function information i31 and cyber attack information i32.

Information processing apparatus 40 transmits information indicating the relationship between the accident in which vehicle 10 has been involved and the cyber attack to management server 70 (step S90). Management server 70 verifies the vehicle accident based on the information indicating the relationship between the accident in which vehicle 10 has been involved and the cyber attack.

The information processing method according to the present embodiment includes: obtaining surrounding information i20 of vehicle 10 and information i30 on the in-vehicle log of vehicle 10; deriving a relationship between an accident in which vehicle 10 has been involved and a cyber attack to which vehicle 10 has been subjected based on surrounding information i20 and information i30 on the in-vehicle log; and outputting information indicating the relationship between the accident in which vehicle 10 has been involved and the cyber attack.

Thus, by deriving the relationship between the accident in which vehicle 10 has been involved and the cyber attack to which vehicle 10 has been subjected based on surrounding information i20 and information i30 on the in-vehicle log of vehicle 10, insufficient verification of the vehicle accident can be reduced.

### [Variation 1]

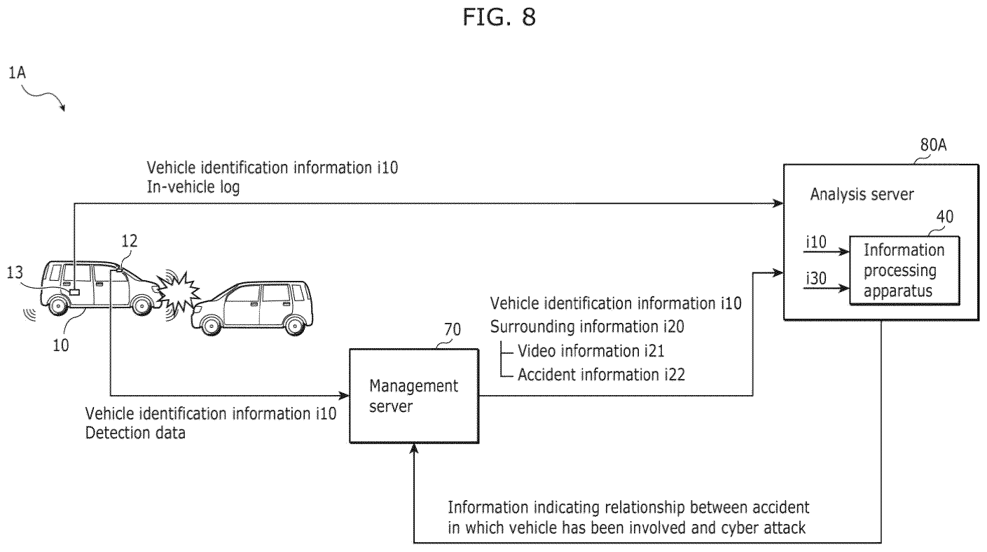

The configuration of information processing system 1A according to Variation 1 of the embodiment will be described with reference to FIGS. 8 to 10. In Variation 1, an example in which information processing apparatus 40 is provided within analysis server 80A will be described.

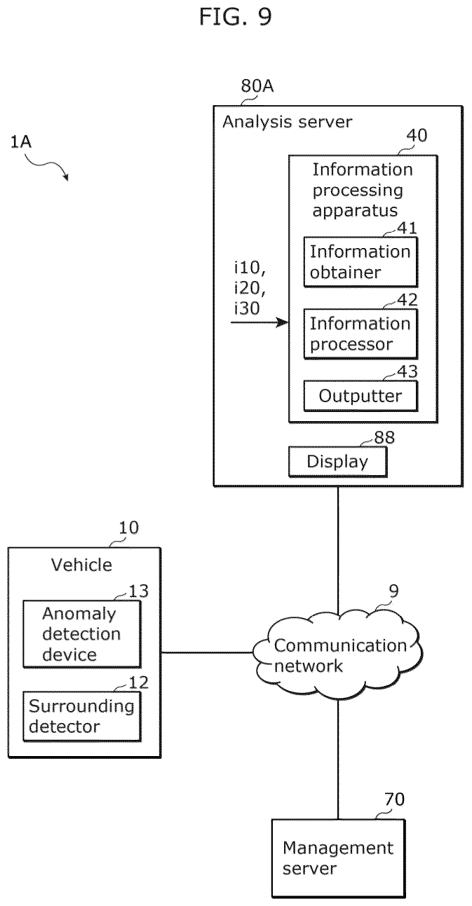

FIG. 8 is a schematic diagram illustrating a schematic configuration of information processing system 1A according to Variation 1. FIG. 9 is a block diagram illustrating the functional configuration of information processing system 1A.

As illustrated in FIGS. 8 and 9, information processing system 1A includes analysis server 80A and management server 70. Information processing apparatus 40 according to Variation 1 is provided inside analysis server 80A.

Vehicle 10 can communicate with analysis server 80A and management server 70 via communication network 9. Analysis server 80A and management server 70 can communicate with each other via communication network 9.

Surrounding detector 12 of vehicle 10 outputs the detection data detected by surrounding detector 12 to management server 70 via communication network 9.

Management server 70 analyzes the detection data output from vehicle 10 to obtain surrounding information i20 of vehicle 10. Surrounding information i20 includes video information i21 on the outside of vehicle 10 and accident information i22 on an accident in which vehicle 10 has been involved. Management server 70 outputs surrounding information i20 including video information i21 and accident information i22 to analysis server 80A via communication network 9.

Anomaly detection device 13 outputs the in-vehicle log including the detection result of whether an anomaly has occurred in the in-vehicle system to analysis server 80A via communication network 9.

Analysis server 80A analyzes the in-vehicle log output from vehicle 10 to obtain driving function information i31 indicating whether an anomaly has occurred in the driving function of vehicle 10. Analysis server 80A also analyzes the in-vehicle log to detect whether a cyber attack has occurred and obtain cyber attack information i32 as to whether a cyber attack has occurred. Analysis server 80A also derives the relationship between whether an anomaly has occurred in the driving function of vehicle 10 and whether a cyber attack has occurred.

Analysis server 80A outputs information i30 on the in-vehicle log, including driving function information i31 and cyber attack information i32, to information processing apparatus 40 via communication network 9. Analysis server 80A also outputs identification information i10 of vehicle 10 that has been involved in the accident to information processing apparatus 40.

As illustrated in FIG. 9, information processing apparatus 40 includes information obtainer 41, information processor 42, and outputter 43.

Information obtainer 41 obtains surrounding information 120 output from management server 70, identification information i10 of vehicle 10, and information on the accident occurrence time. Surrounding information i20 includes video information i21 and accident information i22. Information obtainer 41 also obtains information i30 on the in-vehicle log and identification information i10 of vehicle 10, which have been computationally processed by analysis server 80A. Information 130 on the in-vehicle log includes driving function information i31, cyber attack information i32, and information on the anomaly occurrence time.

Information processor 42 collates identification information i10 of vehicle 10 and the accident occurrence time, output from management server 70, with identification information i10 of vehicle 10 and the anomaly occurrence time, output from analysis server 80A, identifies the target vehicle, and performs the following processing.

Information processor 42 derives the relationship between the accident in which vehicle 10 has been involved and the cyber attack on vehicle 10 based on surrounding information i20 and information i30 on the in-vehicle log. For example, information processor 42 derives the relationship between the accident in which vehicle 10 has been involved and the cyber attack based on the relationship between accident information i22 and driving function information i31, as well as the relationship between driving function information i31 and cyber attack information i32.

Outputter 43 outputs information indicating Outputter 43 the relationship between the accident in which vehicle 10 has been involved and the cyber attack to display 88 provided in analysis server 80A. Display 88 is, for example, a liquid crystal display device or the like, and displays information indicating the relationship between the accident in which vehicle 10 has been involved and the cyber attack.

Outputter 43 also outputs information indicating the relationship between the accident in which vehicle 10 has been involved and the cyber attack to management server 70. Management server 70 verifies the vehicle accident based on the information indicating the relationship between the accident in which vehicle 10 has been involved and the cyber attack.

Information processing system 1A according to Variation 1 also derives the relationship between the accident in which vehicle 10 has been involved and the cyber attack to which vehicle 10 has been subjected based on surrounding information i20 and information i30 on the in-vehicle log. Therefore, insufficient verification of the vehicle accident can be reduced.

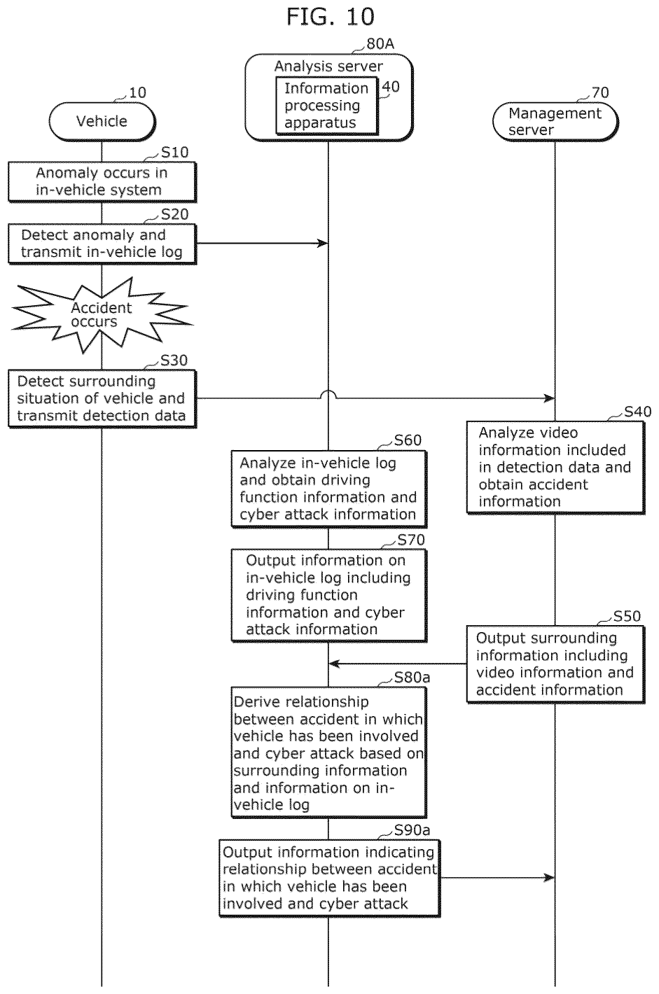

The operation of information processing system 1A described above will be described with reference to FIG. 10.

FIG. 10 is a sequence diagram illustrating the operation of information processing system 1A according to Variation 1.

First, vehicle 10 is subjected to a cyber attack, causing an anomaly in the in-vehicle system of vehicle 10 (step S10).

Anomaly detection device 13 of vehicle 10 detects an anomaly occurring in the in-vehicle system and transmits the in-vehicle log to analysis server 80A (step S20).

The anomaly in the in-vehicle system causes an accident to occur in vehicle 10. Surrounding detector 12 of vehicle 10 transmits detection data of vehicle 10 at the time of the accident to management server 70 (step S30).

Management server 70 analyzes video information i21 included in the detection data and obtains accident information 122 (step S40). Management server 70 transmits surrounding information i20 including video information i21 and accident information i22 to analysis server 80A (step S50).

Meanwhile, analysis server 80A analyzes the in-vehicle log transmitted from anomaly detection device 13 and obtains driving function information i31 and cyber attack information i32 (step S60). Analysis server 80A outputs information i30 on the in-vehicle log, including driving function information i31 and cyber attack information i32, to information processing apparatus 40 inside analysis server 80A (step S70). As long as steps S60 and S70 are executed after step S20, execution of steps S60 and S70 may take place before or at the same time as steps S40 and S50.

Information processing apparatus 40 derives the relationship between the accident in which vehicle 10 has been involved and the cyber attack to which vehicle 10 has been subjected based on surrounding information i20 output from management server 70 and information i30 on the in-vehicle log transmitted from analysis server 80A (step S80a).

Information processing apparatus 40 transmits information indicating the relationship between the accident in which vehicle 10 has been involved and the cyber attack to management server 70 (step S90a). Management server 70 verifies the vehicle accident based on the information indicating the relationship between the accident in which vehicle 10 has been involved and the cyber attack.

Thus, by deriving the relationship between the accident in which vehicle 10 has been involved and the cyber attack to which vehicle 10 has been subjected based on surrounding information i20 and information i30 on the in-vehicle log, insufficient verification of the vehicle accident can be reduced.

### [Variation 2]

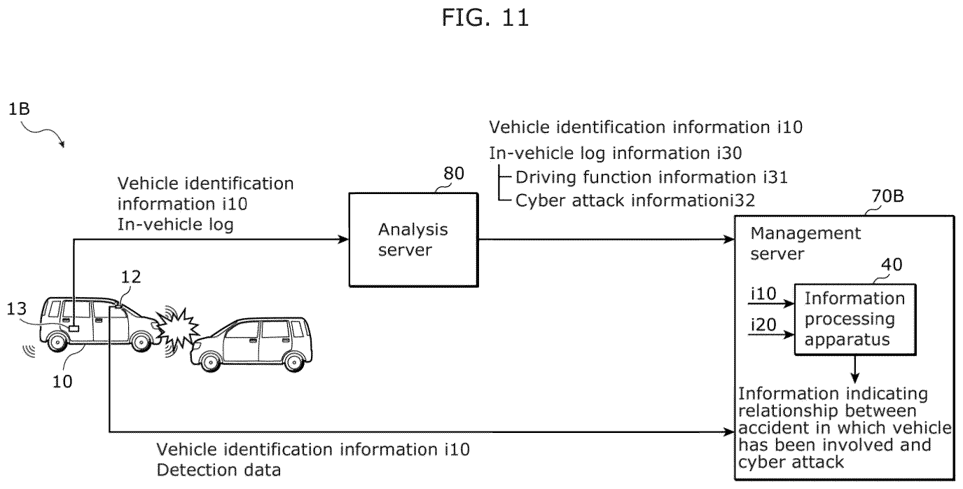

The configuration of information processing system 1B according to Variation 2 of the embodiment will be described with reference to FIGS. 11 to 13. In Variation 2, an example in which information processing apparatus 40 is provided within management server 70B will be described.

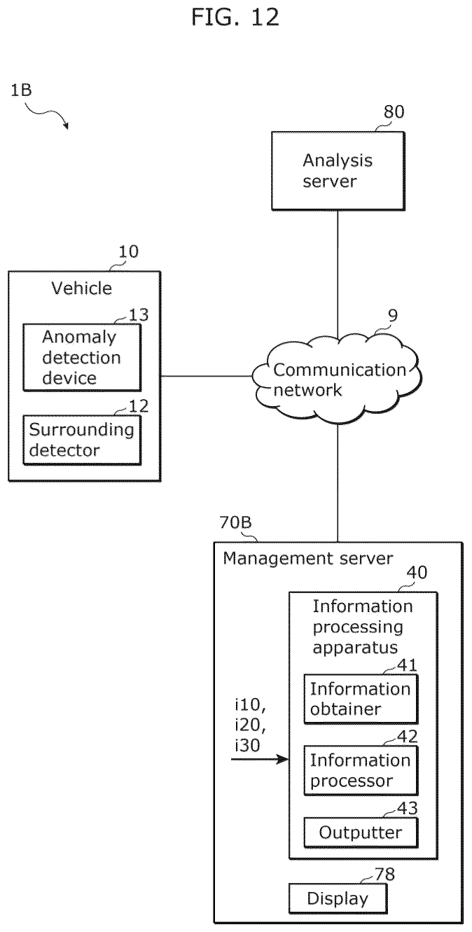

FIG. 11 is a schematic diagram illustrating a schematic configuration of information processing system 1B according to Variation 2. FIG. 12 is a block diagram illustrating the functional configuration of information processing system 1B.

As illustrated in FIGS. 11 and 12, information processing system 1B includes analysis server 80 and management server 70B. Information processing apparatus 40 according to Variation 2 is provided inside management server 70B.

Vehicle 10 can communicate with analysis server 80 and management server 70B via communication network 9. Analysis server 80 and management server 70B can communicate with each other via communication network 9.

Surrounding detector 12 of vehicle 10 outputs the detection data detected by surrounding detector 12 to management server 70B via communication network 9.

Management server 70B analyzes the detection data output from vehicle 10 to obtain surrounding information i20 of vehicle 10. Surrounding information i20 includes video information i21 on the outside of vehicle 10 and accident information i22 on an accident in which vehicle 10 has been involved. Management server 70B outputs surrounding information i20 including video information i21 and accident information i22 to information processing apparatus 40 inside management server 70B. Management server 70B also outputs identification information i10 of vehicle 10 and information on the accident occurrence time to information processing apparatus 40.

Anomaly detection device 13 outputs an in-vehicle log including the detection result of whether an anomaly has occurred in the in-vehicle system to analysis server 80 via communication network 9.

Analysis server 80 analyzes the in-vehicle log output from vehicle 10 to obtain driving function information i31 indicating whether an anomaly has occurred in the driving function of vehicle 10. Analysis server 80 analyzes the in-vehicle log to detect whether a cyber attack has occurred and obtain cyber attack information i32 as to whether a cyber attack has occurred. Analysis server 80 derives the relationship between whether an anomaly has occurred in the driving function of vehicle 10 and whether a cyber attack has occurred.

Analysis server 80 outputs information i30 on the in-vehicle log, including driving function information i31 and cyber attack information i32, to management server 70B via communication network 9. Analysis server 80 also outputs identification information i10 of vehicle 10 that has been involved in the accident to management server 70B.

As illustrated in FIG. 12, information processing apparatus 40 includes information obtainer 41, information processor 42, and outputter 43.

Information obtainer 41 obtains surrounding information i20, identification information i10 of vehicle 10, and information on the accident occurrence time, which have been computationally processed by management server 70B. Surrounding information i20 includes video information i21 and accident information i22. Information obtainer 41 also obtains information i30 on the in-vehicle log and identification information i10 of vehicle 10 output from analysis server 80. Information i30 on the in-vehicle log includes driving function information i31, cyber attack information i32, and information on the anomaly occurrence time.

Information processor 42 collates identification information i10 of vehicle 10 and the accident occurrence time, output from management server 70B, with identification information i10 of vehicle 10 and the anomaly occurrence time, output from analysis server 80, identifies the target vehicle, and performs the following processing.

Information processor 42 derives the relationship between the accident in which vehicle 10 has been involved and the cyber attack on vehicle 10 based on surrounding information i20 and information i30 on the in-vehicle log. For example, information processor 42 derives the relationship between the accident in which vehicle 10 has been involved and the cyber attack based on the relationship between accident information i22 and driving function information i31, as well as the relationship between driving function information i31 and cyber attack information i32.

Outputter 43 outputs information indicating the relationship between the accident in which vehicle 10 has been involved and the cyber attack to display 78 provided in management server 70B. Display 78 is, for example, a liquid crystal display device or the like, and displays information indicating the relationship between the accident in which vehicle 10 has been involved and the cyber attack.

Outputter 43 also outputs information indicating the relationship between the accident in which vehicle 10 has been involved and the cyber attack to the central processing unit (CPU) of management server 70B. Management server 70B verifies the vehicle accident based on the information indicating the relationship between the accident in which vehicle 10 has been involved and the cyber attack.

Information processing system 1B according to Variation 2 also derives the relationship between the accident in which vehicle 10 has been involved and the cyber attack to which vehicle 10 has been subjected based on surrounding information 120 and information i30 on the in-vehicle log. Therefore, insufficient verification of the vehicle accident can be reduced.

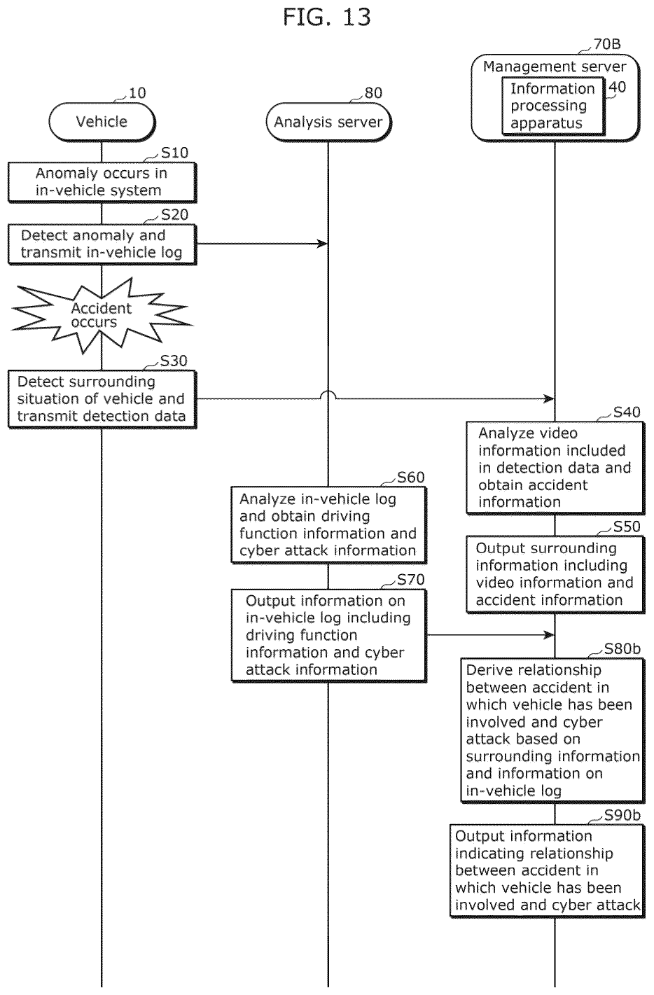

The operation of information processing system 1B described above will be described with reference to FIG. 13.

FIG. 13 is a sequence diagram illustrating the operation of information processing system 1B according to Variation 2.

First, vehicle 10 is subjected to a cyber attack, causing an anomaly in the in-vehicle system of vehicle 10 (step S10).

Anomaly detection device 13 of vehicle 10 detects an anomaly occurring in the in-vehicle system and transmits the in-vehicle log to analysis server 80 (step S20).

The anomaly in the in-vehicle system causes an accident to occur in vehicle 10. Surrounding detector 12 of vehicle 10 transmits detection data of vehicle 10 at the time of the accident to management server 70B (step S30).

Management server 70B analyzes video information i21 included in the detection data and obtains accident information i22 (step S40). Management server 70B outputs surrounding information i20 including video information i21 and accident information i22 to information processing apparatus 40 inside management server 70B (step S50).

Meanwhile, analysis server 80 analyzes the in-vehicle log transmitted from anomaly detection device 13 and obtains driving function information i31 and cyber attack information i32 (step S60). Analysis server 80 transmits information i30 on the in-vehicle log, including driving function information i31 and cyber attack information i32, to management server 70B (step S70). As long as steps S60 and S70 are executed after step S20, execution of steps S60 and S70 may take place before or at the same time as steps S40 and S50.

Information processing apparatus 40 derives the relationship between the accident in which vehicle 10 has been involved and the cyber attack to which vehicle 10 has been subjected based on surrounding information i20 transmitted from management server 70B and information i30 on the in-vehicle log output from analysis server 80 (step S80b).

Information processing apparatus 40 outputs information indicating the relationship between the accident in which vehicle 10 has been involved and the cyber attack to the CPU of management server 70B (step S90b). Management server 70B verifies the vehicle accident based on the information indicating the relationship between the accident in which vehicle 10 has been involved and the cyber attack.

Thus, by deriving the relationship between the accident in which vehicle 10 has been involved and the cyber attack to which vehicle 10 has been subjected based on surrounding information 120 and information i30 on the in-vehicle log, insufficient verification of the vehicle accident can be reduced.

### SUMMARY

Information processing systems 1, 1A, 1B, and the like according to one aspect of the present disclosure will be exemplified below.

Information processing system of Example 1 includes: information obtainer 41 that obtains surrounding information i20 of vehicle 10 and information i30 on the in-vehicle log of vehicle 10; information processor 42 that derives the relationship between an accident in which vehicle 10 has been involved and a cyber attack to which vehicle 10 has been subjected based on surrounding information i20 and information i30 on the in-vehicle log; and outputter 43 that outputs information indicating the relationship between the accident in which vehicle 10 has been involved and the cyber attack.

Thus, by deriving the relationship between the accident in which vehicle 10 has been involved and the cyber attack to which vehicle 10 has been subjected based on surrounding information i20 and information i30 on the in-vehicle log of vehicle 10, insufficient verification of the vehicle accident can be reduced.

The information processing system of Example 2 is the information processing system of Example 1, wherein surrounding information i20 may include accident information i22 on the accident in which vehicle 10 has been involved, and information i30 on the in-vehicle log may include driving function information i31 indicating whether an anomaly has occurred in the driving function of vehicle 10 and cyber attack information i32 as to whether a cyber attack has occurred.

Accordingly, the relationship between the accident in which vehicle 10 has been involved and the cyber attack to which vehicle 10 has been subjected can be derived based on accident information i22, driving function information i31, and cyber attack information i32. Therefore, insufficient verification of the vehicle accident can be reduced.

The information processing system of Example 3 is the information processing system of Example 2, wherein information processor 42 derives the relationship between the accident in which vehicle 10 has been involved and the cyber attack based on the relationship between accident information i22 and driving function information i31, and the relationship between driving function information i31 and cyber attack information i32.

Accordingly, the relationship between the accident in which vehicle 10 has been involved and the cyber attack to which vehicle 10 has been subjected can be derived based on the relationship among accident information i22, driving function information i31, and cyber attack information i32. Therefore, insufficient verification of the vehicle accident can be reduced.

The information processing system of Example 4 is the information processing system according to any one of Examples 1 to 3, wherein surrounding information i20 may include video information i21 on the outside of vehicle 10.

Accordingly, the relationship between the accident in which vehicle 10 has been involved and the cyber attack to which vehicle 10 has been subjected can be derived based on video information i21 on the outside of vehicle 10. Therefore, insufficient verification of the vehicle accident can be reduced.

The information processing system of Example 5 is the information processing system according to any one of Examples 1 to 4, wherein surrounding information i20 may include information for a certain time period before and after an accident involving vehicle 10.

Accordingly, the relationship between the accident in which vehicle 10 has been involved and the cyber attack to which vehicle 10 has been subjected can be derived based on the information for a certain time period before and after the accident. Therefore, insufficient verification of the vehicle accident can be reduced.

The information processing system of Example 6 is the information processing system according to Example 2 or 3, wherein driving function information i31 may include information indicating whether an anomaly has occurred in at least one of the steering wheel, the brake, or the accelerator of vehicle 10.

Accordingly, the relationship between the accident in which vehicle 10 has been involved and the cyber attack to which vehicle 10 has been subjected can be derived based on an anomaly in at least one the steering wheel, the brake, or the accelerator of vehicle 10. Therefore, insufficient verification of the vehicle accident can be reduced.

The information processing system of Example 7 is the information processing system according to Example 2 or 3, wherein cyber attack information i32 may include an attack scenario on the in-vehicle system of vehicle 10.

Accordingly, the relationship between the accident in which vehicle 10 has been involved and the cyber attack to which vehicle 10 has been subjected can be derived based on the attack scenario on the in-vehicle system. Therefore, insufficient verification of the vehicle accident can be reduced.

The information processing system of Example 8 is the information processing system according to any one of Examples 1 to 7, wherein information obtainer 41 may further obtain identification information i10 of vehicle 10, and information processor 42 may derive the relationship between the accident in which vehicle 10 has been involved and the cyber attack.

Accordingly, vehicle 10 that has been involved in the accident can be identified, and the relationship between the accident in which vehicle 10 has been involved and the cyber attack to which vehicle 10 has been subjected can be derived. Therefore, insufficient verification of the vehicle accident can be reduced.

Information processing apparatus 40 of Example 9 includes: information obtainer 41 that obtains surrounding information i20 of vehicle 10 and information i30 on the in-vehicle log of vehicle 10; information processor 42 that derives the relationship between an accident in which vehicle 10 has been involved and a cyber attack to which vehicle 10 has been subjected based on surrounding information i20 and information i30 on the in-vehicle log; and outputter 43 that outputs information indicating the relationship between the accident in which vehicle 10 has been involved and the cyber attack.

Thus, by deriving the relationship between the accident in which vehicle 10 has been involved and the cyber attack to which vehicle 10 has been subjected based on surrounding information 120 and information i30 on the in-vehicle log of vehicle 10, insufficient verification of the vehicle accident can be reduced.

The information processing method of Example 10 includes: obtaining surrounding information i20 of vehicle 10 and information i30 on the in-vehicle log of vehicle 10; deriving a relationship between an accident in which vehicle 10 has been involved and a cyber attack to which vehicle 10 has been subjected based on surrounding information i20 and information i30 on the in-vehicle log; and outputting information indicating the relationship between the accident in which vehicle 10 has been involved and the cyber attack.

Thus, by deriving the relationship between the accident in which vehicle 10 has been involved and the cyber attack to which vehicle 10 has been subjected based on surrounding information i20 and information i30 on the in-vehicle log of vehicle 10, insufficient verification of the vehicle accident can be reduced.

The program of Example 11 is a program for causing a computer to execute the information processing method according to Example 10.

According to this program, the same effect as the above information processing method can be achieved.

### OTHER EMBODIMENTS

The information processing system and the like according to one or more aspects has been described based on the embodiment and the like, but the present disclosure is not limited to the embodiment and the like. Unless deviating from the gist of the present disclosure, the present disclosure may include a form of the present embodiment with various modifications applied or a form constructed by combining components of different embodiments.

In the information processing system described above, the example of obtaining surrounding information i20 using the external video data of vehicle 10 is shown, but the present disclosure is not limited thereto. The information processing system may verify the vehicle accident using, in addition to surrounding information i20, internal video data of vehicle 10, video data from a surveillance camera, video data from a drive recorder of a surrounding vehicle, video data posted on a social networking service (SNS), and the like as external video data.

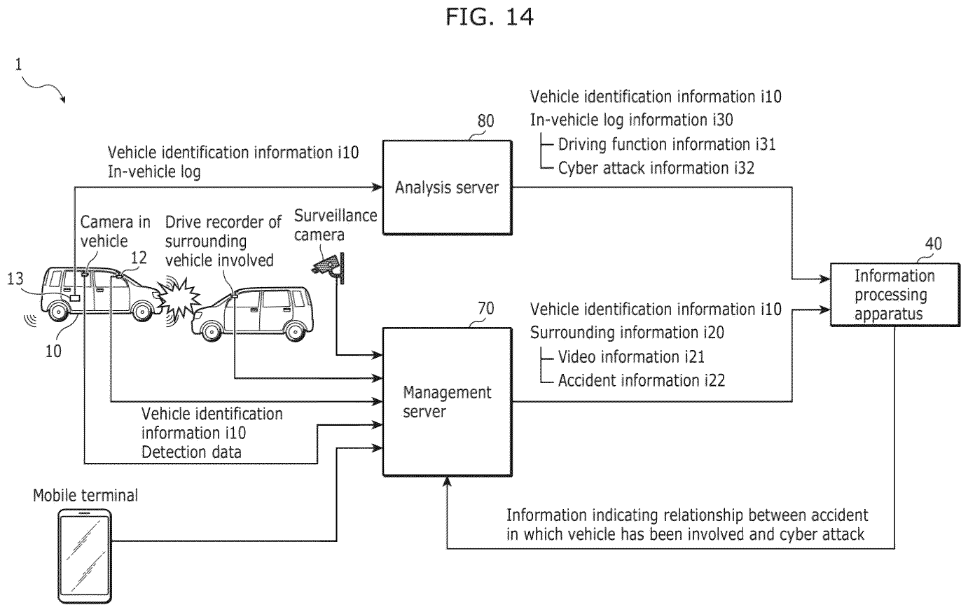

FIG. 14 is a diagram illustrating another example of the information processing system according to the embodiment.

In FIG. 14, a camera in the vehicle, a drive recorder of a surrounding vehicle involved, a surrounding surveillance camera, and a mobile terminal that transmits SNS and other information are connected to management server 70 in a communicable manner. With this configuration, more information on the time of the accident is collected, making it easier to include video data capturing the moment of the accident in the external video data. The insurance company that operates management server 70 can analyze the accident, including video data provided by the surrounding vehicle involved in the accident or by the police. Thus, the information processing system may verify the vehicle accident using, in addition to surrounding information i20, internal video data of vehicle 10, video data from the surveillance camera, video data from the drive recorder of the surrounding vehicle, and video data posted on SNS, and the like.

In the above information processing system, the example of obtaining surrounding information i20 using the external video data of vehicle 10 is shown, but in addition to surrounding information i20, the video data inside vehicle 10 may be used to verify the vehicle accident. For example, the information processing system may use a driver monitoring unit provided within vehicle 10 to obtain video data of the driver at the time of the accident and verify the vehicle accident using the video data of the driver.

In the above embodiment and the like, each component may be configured with dedicated hardware or implemented by executing a software program suitable for each component. Each component may be implemented by a program executor such as a CPU or a processor reading and executing a software program recorded in a recording medium such as a hard disk or a semiconductor memory.

The order in which each step is executed in the flowchart is intended to specifically illustrate the present disclosure and may be an order other than the above. Some of the above steps may be executed simultaneously (in parallel) with other steps, and some of the steps may not be executed.

The division of the functional blocks in the block diagram is an example, and a plurality of functional blocks may be implemented as one functional block, one functional block may be divided into a plurality of functional blocks, or some functions may be transferred to other functional blocks. The functions of a plurality of functional blocks with similar functions may be processed in parallel or time division by a single piece of hardware or software.

The apparatus according to the above embodiment and the like may be implemented as a single device or implemented by a plurality of devices. When the information processing apparatus is implemented by a plurality of devices, the components of the information processing apparatus may be distributed to the plurality of devices in any manner. For example, at least some functions of the component of the information processing apparatus may be provided by a vehicle or other server. When the information processing apparatus is implemented by a plurality of devices, the communication method between the devices is not particularly limited and may be wireless or wired communication. Wireless and wired communications may be combined between devices.

Each of the components described in the above embodiment and the like may be implemented as software or may be implemented as a large-scale integration (LSI), which is typically an integrated circuit. These components may be individually integrated into a single chip or may be integrated into a single chip to include part or all of the components. The circuit is referred to as an LSI here but may also be called an IC, system LSI, super LSI, or ultra LSI, depending on the degree of integration. The integrated circuit method is not limited to an LSI and may also be implemented using a dedicated circuit (a general-purpose circuit that executes a dedicated program) or a general-purpose processor. After manufacturing an LSI, a programmable field-programmable gate array (FPGA) or a reconfigurable processor that can reconfigure the connections or settings of circuit cells in the LSI may be used. Furthermore, when an integrated circuit technology that replaces LSI appears due to advances in semiconductor technology or another derived technology, the components may naturally be integrated using such technology.

A system LSI is an ultra-multifunctional LSI manufactured by integrating a plurality of processors on a single chip and specifically refers to a computer system including a microprocessor, read-only memory (ROM), random-access memory (RAM), and the like. A computer program is stored in the ROM. The system LSI achieves its function by operating the microprocessor according to the computer program.

One aspect of the present disclosure may be a computer program that causes a computer to execute each of the characteristic steps included in the above information processing method.

For example, the program may be a program for causing a computer to execute the steps. One aspect of the present disclosure may be a computer-readable non-temporary recording medium having such a program recorded thereon. For example, such a program may be recorded on a recording medium and then distributed or circulated. For example, by installing the distributed program in an apparatus that includes another processor and causing the processor to execute the program, the apparatus can be caused to perform each of the processes described above.

While various embodiments have been described herein above, it is to be appreciated that various changes in form and detail may be made without departing from the spirit and scope of the present disclosure as presently or hereafter claimed.

### FURTHER INFORMATION ABOUT TECHNICAL BACKGROUND TO THIS APPLICATION

The disclosure of the following patent application including specification, drawings, and claims is incorporated herein by reference in their entirety: Japanese Patent Application No. 2024-096509 filed on Jun. 14, 2024.

### INDUSTRIAL APPLICABILITY

The present disclosure is useful as an information processing system or the like for verifying a vehicle accident.

1. An information processing system comprising:
an information obtainer that obtains surrounding information of a vehicle and in-vehicle log information indicating an in-vehicle log of the vehicle;
an information processor that derives, based on the surrounding information and the in-vehicle log information indicating an in-vehicle log of the vehicle, a relationship between an accident in which the vehicle has been involved and a cyber attack to which the vehicle has been subjected; and
an outputter that outputs information indicating the relationship between the accident in which the vehicle has been involved and the cyber attack.

2. The information processing system according to claim 1,
wherein the surrounding information includes accident information on the accident in which the vehicle has been involved, and
the in-vehicle log information indicating an in-vehicle log of the vehicle includes driving function information indicating whether an anomaly has occurred in the driving function of the vehicle and cyber attack information as to whether the cyber attack has occurred.

3. The information processing system according to claim 2,
wherein the information processor derives the relationship between the accident in which the vehicle has been involved and the cyber attack, based on a relationship between the accident information and the driving function information and a relationship between the driving function information and the cyber attack information.

4. The information processing system according to claim 1,
wherein the surrounding information includes video information indicating a video showing an outside of the vehicle.

5. The information processing system according to claim 1,
wherein the surrounding information includes information of a certain time period before and after the accident involving the vehicle.

6. The information processing system according to claim 2,
wherein the driving function information includes information indicating whether an anomaly has occurred in at least one of a steering wheel, a brake, or an accelerator of the vehicle.

7. The information processing system according to claim 2,
wherein the cyber attack information includes a scenario of an attack on an in-vehicle system of the vehicle.

8. The information processing system according to claim 1,
wherein the information obtainer further obtains identification information of the vehicle, and
the information processor derives the relationship between the accident in which the vehicle has been involved and the cyber attack.

9. An information processing apparatus comprising:
an information obtainer that obtains surrounding information of a vehicle and in-vehicle log information indicating an in-vehicle log of the vehicle;
an information processor that derives, based on the surrounding information and the in-vehicle log information indicating an in-vehicle log of the vehicle, a relationship between an accident in which the vehicle has been involved and a cyber attack to which the vehicle has been subjected; and
an outputter that outputs information indicating the relationship between the accident in which the vehicle has been involved and the cyber attack.

10. An information processing method comprising:
obtaining surrounding information of a vehicle and in-vehicle log information indicating an in-vehicle log of the vehicle;
deriving, based on the surrounding information and the in-vehicle log information indicating an in-vehicle log of the vehicle, a relationship between an accident in which the vehicle has been involved and a cyber attack to which the vehicle has been subjected; and
outputting information indicating the relationship between the accident in which the vehicle has been involved and the cyber attack.
